(19) United States
(12) Patent Application Publication
(10) Pub. No.: US 2005/0125271 A1
(43) Pub. Date: Jun. 9, 2005

(54) Web services project planning

(76) Inventor: Christopher John Peltz, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/731,061

(22) Filed: Dec. 9, 2003

(51) Int. Cl. G06F 17/60

(52) U.S. Cl. 705/7

(57) ABSTRACT

Systems, methodologies, media, and other embodiments associated with producing a metaplan for a Web services development project are described. One exemplary method includes establishing sets of criteria for planning a Web services project and selectively organizing selected members of the sets of criteria into a metaplan.

### BACKGROUND

Software development projects have long employed techniques like structured design and object-oriented design to facilitate planning and to produce small scale software components. On a larger scale, traditional monolithic software projects have employed techniques like the waterfall model and various prototyping processes. But with the rapid growth of distributed systems, the Internet, markup languages, messaging, and so on, new types of projects may have gone wanting for more formal planning techniques.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example method for producing a Web services project metaplan.

FIG. 2 illustrates an example method for producing a Web services project plan.

FIG. 3 illustrates another example method for producing a Web services project metaplan.

FIG. 4 illustrates an example method for producing a Web services project development strategy.

FIG. 5 illustrates an example method for incrementally refining a Web services project plan.

FIG. 6 illustrates an example system for producing a Web services project plan.

FIG. 7 illustrates an example method for producing a Web services project metaplan.

### DETAILED DESCRIPTION

A metaplan can be considered a plan about planning, like metadata is data about data. As employed in this application, a metaplan is an article of manufacture that facilitates planning a Web services project. A metaplan can include items to consider when making a plan for a Web services project. For example, a metaplan may identify data to be collected to facilitate making a plan like, budget questions, personnel questions, business objectives, technical data, and so on. A Web services project can be planned by referencing a metaplan, selecting portions that are relevant to a specific Web services project, and developing a plan from the selected portions. A metaplan can include portions that facilitate static and/or dynamic planning of a Web services project. For example, a metaplan may include information about how to analyze an ongoing project. Thus a plan derived from a metaplan can include information about an ongoing project.

From one perspective, a Web service is a software system designed to support message based interoperable machine-to-machine interaction over a network. A Web service may have an interface described in a machine processable format. The machine processable format may be, for example, a Web services description language (WSDL) that is an extensible markup language (XML) formatted language that describes Web service capabilities as collections of communication endpoints capable of exchanging messages. The messages may be exchanged according to, for example, a lightweight XML-based message protocol like SOAP, which facilitates encoding information in Web service request/response messages that are to be transmitted over a network. SOAP messages may be operating system and/or protocol independent and thus may be transmitted using Internet protocols like simple mail transfer protocol (SMTP), multipurpose Internet mail extensions (MIME), hypertext transfer protocol (HTTP), and so on.

From another perspective, a Web service may be an abstract notion that is implemented by an instance of an agent. The instantiated agent may receive physical messages and provide physical response messages that implement the services described by the abstract set of functionality. In this perspective, Web services may be characterized as provider agents that implement a service and requester agents that request services on behalf of a requester. The agents may be considered endpoints and/or intermediaries that operate on document oriented and/or procedure oriented information. The information may be stored, for example, in XML data in the messages. The endpoints and/or intermediaries may be located using, for example, a web-based distributed directory involved with universal description discovery and integration (UDDI). Thus, Web services may be employed in a service-oriented architecture (SOA), which may include a collection of services that communicate with each other. The communication may involve, for example, simple data passing or it could involve two or more services coordinating some activity.

Thus, in one example, Web services facilitate integrating Web-based applications using XML, SOAP, WSDL, and UDDI over an Internet Protocol (IP) based network. Web services may be described in WSDL, listed in UDDI, and messaged using SOAP messages with XML tagged data. Unlike many graphical user interface (GUI) dominated client/server systems, Web services provide a programmatic interface to facilitate sharing business logic, data, processes, and so on across a network. Therefore, Web services can be software components exposed on a network by a platform-independent interface definition. Thus, Web services may provide a reasonably lightweight and open standards-based method for computer-computer communications.

Web services applications may employ a simple Java client proxy object local to the application that provides an application programming interface similar to the interface for the Web service. The client proxy object may broker communications with the Web service. While some architectures may employ client proxy objects, other architectures may benefit from a more loosely coupled architecture. Web services based applications may consume a set of Web services, and thus may employ integration and/or coordination logic to effectively consume these Web services.

Planning a Web services project can involve considering factors that may not have been conventionally considered and/or considering them from different points of view that encompass Web services technology. Therefore, this application describes example systems and methods for producing a metaplan and/or a plan for a Web services project.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic device, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servlet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

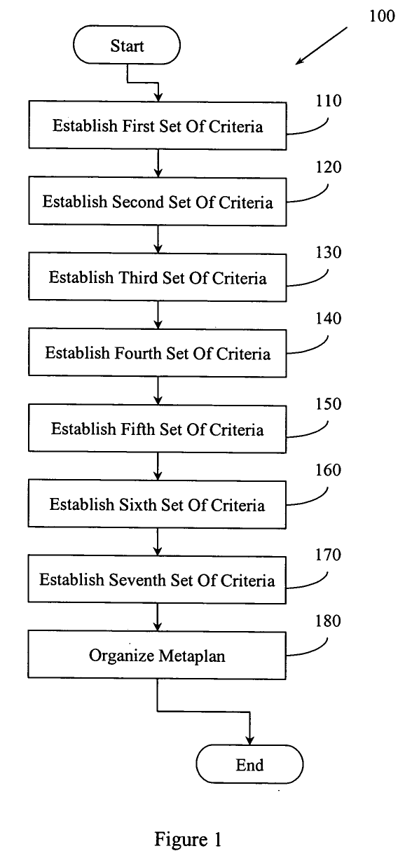

Example methods may be better appreciated with reference to the flow diagrams of FIGS. 1 through 5, and FIG. 7. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 1 illustrates an example method 100 for producing a Web services project metaplan. The metaplan may collect and organize criteria that can be examined to create a plan for a Web services project. Thus, the method 100 may include, at 110, establishing a first set of criteria for calculating a Web services project return on investment. Establishing a set of criteria may include, for example, producing and/or storing questions to be answered, programming data fields for which values can be provided, generating queries that can retrieve data values, populating a data structure with name:value pairs where the name is initialized and the value is not initialized, and so on. The first set of criteria may include, for example, a Web services project development time, a Web services project actual development cost, a Web services project opportunity cost, a Web services project cost savings, a Web services project anticipated effect on revenue, and so on. The Web services project development time may include, for example, a prediction of how long it will take to complete the project, a completion target date for a project, and the like. The actual development cost may concern expenses for time, material, personnel, space and so on while the opportunity cost may concern expenses associated with a second project that is not developed because a first project is developed, and the like.

The method 100 may also include, at 120, establishing a second set of criteria for identifying an existing reusable software component and/or technologies or platforms associated with the software component. The second set of criteria may include, for example, data concerning how long it will take to develop an existing reusable software component into a Web service, how much effort (e.g., manpower, intellectual activity, physical activity) it will take to develop an existing reusable software component into a Web service, how much it will cost to develop an existing reusable software component into a Web service, an actual and/or predicted return on investment associated with the Web service, and so on. Thus, the second set of criteria, in one example, may also facilitate assessing technologies and/or platforms that simplify developing web services.

The method 100 may also include, at 130, establishing a third set of criteria for identifying how to expose an existing software asset (e.g., application, data set) via a Web service. Exposing an existing software asset can provide, for example, new uses and markets for existing data and/or applications. While a legacy system (e.g., a non Web services based application that may not understand/employ XML) may be able to process existing data, a Web service may be able to allow other non-legacy system users to benefit from the processing performed by the legacy system. Additionally, and/or alternatively, a Web-based application may be repurposed into an XML representation. Thus, the third set of criteria may include, for example, data concerning the XML orientation of an existing software asset. XML orientation may model the costs, benefits, issues, and so on involved in migrating an existing software asset to an XML representation. Similarly, the third set of criteria may include data concerning a SOAP orientation (e.g., costs, benefits, issues, associated with accessing the existing data set using SOAP), data concerning WSDL orientation (e.g., costs, benefits, issues, concerning associating the existing software asset with WSDL), and data concerning HTML orientation for the existing software asset. A software asset may include, for example, an application, a data set, and/or a combination of both.

The method 100 may also include, at 140, establishing a fourth set of criteria for determining whether to include a Web service in the Web services project. The fourth set of criteria may include, for example, data concerning the cost of integrating a Web service into a Web services project, the type and amount of information a Web service may expose, which business process needs a Web service may satisfy, the value of integrating a Web service into a Web services project, (where the value may be measured by effects on complexity, time to market, cost, and so on), a predicted effect on return on investment associated with a Web service, how long (e.g., latency) it will take to experience the return on investment, and how measurable the return on investment associated with a Web service is likely to be. The fourth set of criteria may also include, for example, data concerning how efficient a Web service may be, how reliable a Web service may be, how secure a Web service may be, how scaleable a Web service may be, how mature a Web service is, the granularity of a Web service, and to which business process(es) a Web service may be mapped. The fourth set of criteria may also include, for example, data concerning how the Web service uses XML, how the Web service employs WSDL, how the Web service employs SOAP, and so on. Thus, an example metaplan may include a comprehensive set of data that facilitates determining whether to include a Web service in a Web services project. A specific project plan may include a subset of the fourth set of criteria, where the subset facilitates determining whether to include a specific Web service into a specific Web services project. For example, if a Web services project will not expose any data to users, (e.g., provides buy/sell decision based on non-exposed data), then a Web services project plan would likely not include elements of a Web services metaplan concerning information exposure but likely would include metaplan elements concerning business processes to which the Web service may be mapped.

The method 100 may also include, at 150, establishing a fifth set of criteria for determining whether to employ a Web services supporting technology. Web services supporting technologies can include, for example, compilers, interpreters, design tools, mapping tools, XML tag generators, style sheet generators, data dictionaries, and so on. Thus, the fifth set of criteria may include, for example, information concerning the reliability of a Web services supporting technology, the scalability of a Web services supporting technology, the security of a Web services supporting technology, how well the Web services supporting technology interoperates with other tools and/or services, how compliant a Web services supporting technology is with respect to various standards and so on. Similarly, the fifth set of criteria may include data concerning how well a Web services supporting technology facilitates capturing best business practices, how the Web services supporting technology effects development time, how much the Web services supporting technology costs and the like. Additionally and/or alternatively, the fifth set of criteria may include data concerning how language independent a Web services supporting technology is, how platform independent a Web services supporting technology is, how easy it is to learn and/or use a Web services supporting technology, whether the Web services supporting technology supports XML schema mapping, whether the Web services supporting technology employs WSDL and so on. The fifth set of criteria may also include information concerning new and interesting ways in which a tool may facilitate exposing information, and the adaptability for use on and/or with legacy systems of the Web services supporting technology.

The method 100 may also include, at 160, establishing a sixth set of criteria for identifying a Web services development team. The criteria associated with the team may include, for example, criteria concerning developers (e.g., programmers, architects, clients, coders, analysts, designers) and/or resources, technical and/or business-oriented, associated with developing a Web service. The sixth set of criteria may include, for example, information concerning a developer's skill set (e.g., languages, operating systems, operating platforms, development platforms, development tools), a developer's experience on Web services projects and so on. Additionally, and/or alternatively, the sixth set of criteria may include information outside the world of coding like a developer's business knowledge applicable to the Web services project, a developer's willingness to participate in return on investment analysis, and a developer's ability to capture best business practices. Thus, the metaplan can include information concerning how to identify a development team member based on a variety of factors. Some project plan portions may be built that include planning points concerned with programmer business knowledge (e.g., project plan concerning a Web service exposed to executives) while other project plan portions may be built that do include planning points concerned with programmer business knowledge (e.g., project plan portion concerning Web service that generates random encryption code for use by decrypting module).

The method 100 may also include, at 170, establishing a seventh set of criteria for identifying a project collaboration partner and/or how to collaborate with a partner. The seventh set of criteria may include, for example, information concerning a potential partner's experience with previous Web services projects, a potential partner's orientation towards (e.g., experience, bias, adoption of) XML, a partner's orientation towards (e.g., experience, bias, adoption of) WSDL, a partner's ability to agree on tag names and meanings and so on, and a partner's ability to work incrementally and adapt a plan based on the results of early increments. The seventh set of criteria may also include, for example, information concerning how to collaborate with a partner using, for example XML and Web services. For example, a first partner may have XML-enabled applications with which a Web services project can communicate using SOAP and the like while a second partner may have legacy (e.g., non Web services based applications that do not employ XML) with which the Web services project would communicate using an alternate technique. Some Web services projects may not include partners, and thus some plans constructed from a Web services metaplan may not include any elements from the seventh set of criteria, for example.

Actions 110 through 170 thus make a rich set of information concerning planning Web services projects available. As mentioned above, a Web services project may be of a type that does not require an answer to every question that can be posed concerning elements of a Web services metaplan. Thus, for a Web services project, the method 100 may also include selectively organizing members of the first through seventh sets of criteria into a Web services project metaplan that fits the needs of a project, a project design team, a project designer, a project budget, and so on. The metaplan may be stored, for example, on a computer-readable medium, in a memory, in a logic, and so on. Similarly, the sets of criteria and/or questions, queries, data structures, name:value pairs and so on associated with the criteria may be stored, for example, on a computer-readable medium, in a memory, in a logic, and so on.

In one example, a computer-readable medium may store a data structure that includes a first field containing data representing criteria for calculating a Web services project return on investment, a second field containing data representing criteria for identifying an existing reusable software component, a third field containing data representing criteria for identifying how to expose an existing data set via a Web service, a fourth field containing data representing criteria for determining whether to include a Web service in the Web services project, a fifth field containing data representing criteria for determining whether to employ a Web services supporting technology, a sixth field containing data representing criteria for identifying a Web services development team, a seventh field containing data representing criteria for identifying a project collaboration partner, an eighth field containing data representing criteria for analyzing an ongoing Web services development project and a ninth field containing data representing a Web services project metaplan derived from data stored in one or more of the first through eighth fields. In one example, the data fields may facilitate establishing an automated system for assessing the viability of a Web services project. The viability may be assessed, for example, by computing an overall risk for a project based on a weighted sum of selected sets of the criteria. While method 100 describes seven sets of criteria, and while the data structure describes nine fields associated with various sets of criteria, it is to be appreciated that the sets of criteria can be organized into a greater and/or lesser number of sets and that the data structure may have a greater and/or lesser number of fields. Similarly, while method 100 illustrates seven actions establishing seven sets of criteria, it is to be appreciated that a greater and/or lesser number of actions could establish a greater and/or lesser number of criteria.

A Web services project may be built in an incremental manner, with portions (e.g., increments) being observed, tested, analyzed, measured, and so on as they are built. Since the Web services environment may be a widely distributed environment, such field testing, observation and so on can facilitate identifying services that meet, exceed, and/or fall short of, their predicted return on investment. Thus, a Web services project metaplan may include information that facilitates planning a Web services project in a dynamic and iterative manner. Therefore, another example method may include establishing an eighth set of criteria for analyzing an ongoing Web services development project and updating a metaplan to include one or more members of the eighth set of criteria.

While FIG. 1 illustrates various actions occurring in serial, it is to be appreciated that various actions illustrated in FIG. 1 could occur substantially in parallel. By way of illustration, a first process could establish the first three sets of criteria. Similarly, a second process could establish the next four sets of criteria, while a third process could organize the available criteria into a metaplan. While three processes are described, it is to be appreciated that a greater and/or lesser number of processes could be employed and that lightweight processes, regular processes, threads, and other approaches could be employed.

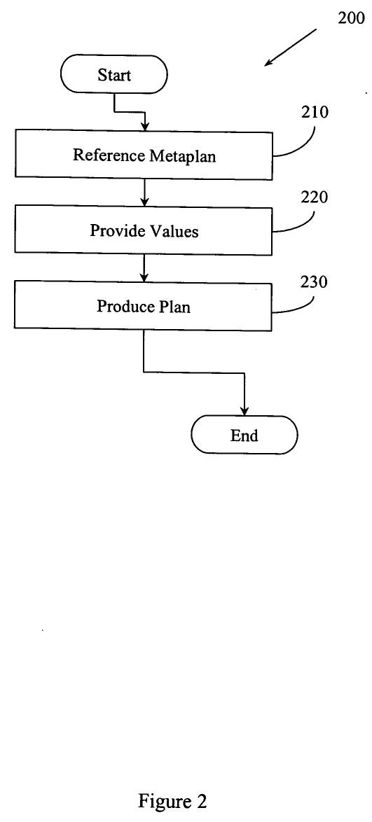

FIG. 2 illustrates an example method 200 for producing a Web services project plan. Whereas FIG. 1 illustrates producing a metaplan, FIG. 2 illustrates producing a plan from a metaplan. The method 200 may include, at 210, referencing a Web services project metaplan like that produced by method 100 in FIG. 1. Referencing a metaplan may include, for example, opening a data file, reading a data structure from a computer-readable medium, generating a series of queries, downloading a metaplan applet, messaging a metaplan logic, and so on. Referencing a metaplan may also include, for example, reading a text document describing steps, criteria, processes, and so on associated with a plan. Thus, the method 200 may have available a rich set of criteria to examine to facilitate planning a Web services project. The method 200 may include, at 220, selectively providing a value(s) for an element(s) of the referenced Web services project metaplan. For example, the metaplan may include several fields for data concerning a Web services developer. At 220, the method 200 may include providing values for a field(s) concerning potential Web services developers who might be available and posses various skills. Planning a Web services project may therefore include considering the developers who are available and their skill sets. For example, if an adequate supply of skilled developers with experience in the type of project being considered is available, then the plan may have an earlier target date than if a small supply of developers who will require some training is available. Thus, the method 200 may also include, at 230, producing the Web services project plan in response to analyzing values for various elements of the metaplan referenced at 210.

In another example, the method 200 may also include developing a portion of the Web services project according to the Web services project plan. While conventional planning techniques may produce an initial plan for an entire project, in one example the method 200 may be employed to build a portion of a Web services project, and then to selectively refine the Web services project plan in response to analyzing the portion of the Web services project. Analyzing the portion of the Web services project can include, for example, evaluating the effects of project elements like existing reusable software components that were included in the developed portion, information exposure techniques employed in the developed portion, Web services supporting technology employed in developing the portion, Web services developer(s) who participated in developing the portion, project collaboration partner(s) who participated in developing the portion, and the Web service that was developed. The effects of these elements may be examined with respect to project properties like complexity, time to market, return on investment, capability and so on. Since a Web services project plan can be refined based on the results of incremental portions that are built, an example method may also include, selectively repeating one or more method acts based, at least in part, on the refined Web services project plan.

While FIG. 2 illustrates various actions occurring in serial, it is to be appreciated that various actions illustrated in FIG. 2 could occur substantially in parallel. By way of illustration, a first process could reference a metaplan to acquire potential project criteria to examine. Similarly, a second process could acquire values for the various criteria, while a third process could produce a plan in response to the provided values. While three processes are described, it is to be appreciated that a greater and/or lesser number of processes could be employed and that lightweight processes, regular processes, threads, and other approaches could be employed.

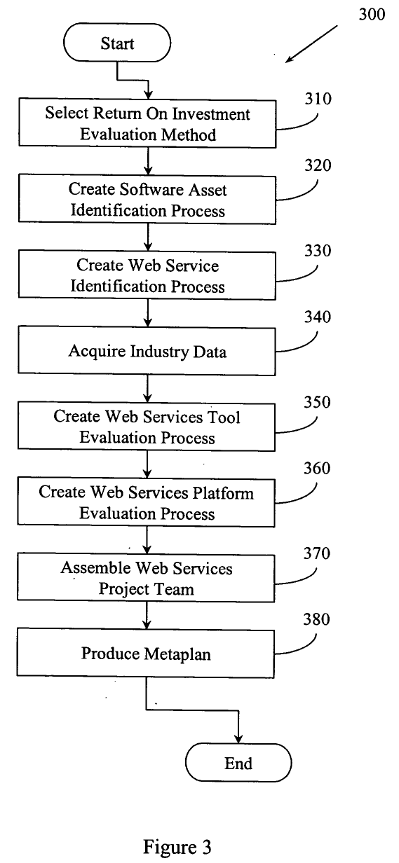

FIG. 3 illustrates another example method 300 for producing a Web services project metaplan. Producing a metaplan facilitates producing a project plan by providing a comprehensive, organized set of Web services project criteria to consider.

The method 300 may include, at 310, selecting a return on investment evaluation method that facilitates evaluating project properties like predicted return on investment and ongoing return on investment. Thus, the method 300 may facilitate producing a focused metaplan that has already chosen between various evaluation techniques. The method 300 may also include, at 320, creating an existing software asset identification process that facilitates identifying an existing software asset that may be included in the Web services project. Whereas a plan may specify which existing software assets to employ and/or how to employ them, a metaplan may provide guidance concerning how to choose existing software assets to employ. At 330, the method 300 may include creating a Web service identification process that facilitates identifying Web services that can be included in the Web services project. Again, a plan may indicate which Web services to include and/or how to employ them while a metaplan may provide guidance concerning how to select a Web service.

The method 300 may also include, at 340, acquiring industry data that characterizes Web services project parameters like available Web services software, emerging Web services software, available Web services hardware, emerging Web services hardware, existing Web services standards, and emerging Web services standards. Thus, the method 300 facilitates acquiring a snapshot of the state of the art with respect to technology that may be relevant to a Web services project. A project plan may then be developed from the information that is captured in the metaplan.

The method 300 may also include, at 350, creating a Web services tool evaluation process that facilitates evaluating information about Web services tools. Thus, a project plan can be built from the metaplan that provides direction concerning how to select a Web services tool. Similarly, the method 300 may include, at 360, creating a Web services platform vendor evaluation process that facilitates evaluating information about a Web services platform vendor(s). Once again this facilitates a project plan being formed from the metaplan that provides direction concerning how to select a Web services platform vendor.

Given the information available in the Web services project metaplan, the method 300 may also include, at 370, assembling a Web services project development team in response to metaplan factors like the predicted return on investment technique, the ongoing return on investment technique, the existing software asset identification technique, the Web services identification technique, the industry data, the Web services tool evaluation process, and the Web services platform vendor evaluation process. With the project team assembled, a project specific Web services project metaplan may be produced at 380. The Web services project metaplan may be directed to a Web services project that can be developed in two or more increments according to a Web services project plan developed from the metaplan. Producing the metaplan may include, for example, storing a data, a process, a process location, a process identifier, a logic identifier, and so on for the selected return on investment evaluation method, the software asset identification process, the Web service identification process, the Web services tool evaluation process, and the Web services platform evaluation process. Similarly, producing the metaplan may include, for example, storing the industry data, data information about the Web services project team.

In one example, the method 300 may include developing a Web services project “increment” according to the Web services project plan developed from the metaplan produced at 380. After the increment is built, the method may include selectively refining the Web services project plan for a remaining Web services project increment(s) based on analyzing the developed Web services project increment. Analyzing the developed Web services project increment may include evaluating, for example, the cost of the increment, revenue generated by the increment, satisfaction with the increment, and information exposed by the increment. As used herein, the term “increment” refers to a subset of a Web services project. An increment may be, for example, all and/or part of a Web service, an agent, an object, a subroutine, a process, a program, and so on. Thus, the term increment is intended to connote one piece of a larger project that can be built as part of the project and then tested, analyzed, observed, integrated, isolated, and so on. The term “portion” is used similarly to increment, and thus may refer to, for example, part of a Web services project. The term increment is chosen to reflect the phased, incremental approach to developing a Web services project that is facilitated by producing a Web services project metaplan and/or plan according to the example methods described herein. Thus, the method 300 may also include selectively repeating one or more acts of method 300 based, at least in part, on analyzing the developed increment.

While FIG. 3 illustrates various actions occurring in serial, it is to be appreciated that various actions illustrated in FIG. 3 could occur substantially in parallel. By way of illustration, a first process could produce a metaplan. Similarly, a second process could produce a plan, while a third process could selectively refine the plan based on observations of various increments developed according to the plan derived from the metaplan. While three processes are described, it is to be appreciated that a greater and/or lesser number of processes could be employed and that lightweight processes, regular processes, threads, and other approaches could be employed.

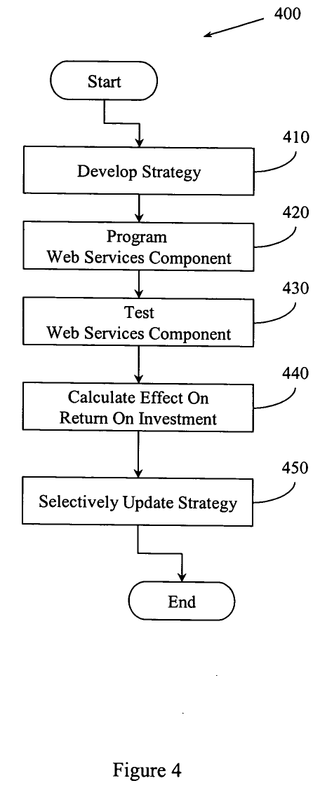

FIG. 4 illustrates an example method for producing a Web services project development strategy. Whereas a metaplan may be a tangible item that can be stored, for example, on a computer-readable medium, a strategy may be a less tangible item. The method 400 may include, at 410, developing a strategy for developing a Web services project that includes one or more Web service components. The components may be, for example, Web services, agents, objects, and so on that can be embodied as software. Thus, the method 400 may also include, at 420, programming a Web service component of the Web services project based on the strategy.

Like the development of a Web services project based on a plan derived from a metaplan can be accomplished incrementally, so too can development based on a strategy developed according to method 400 proceed in a phased approach. Thus, the method 400 may include, at 430, testing the Web service component and, at 440, calculating the effect of the Web service component on a return on investment for the Web services project. With the component built and tested, and with the return on investment calculated, refinements to the strategy developed at 410 can be made. Thus, the method 400 may include, at 450, selectively updating the strategy based on the effect of the Web service component on the return on investment. One input employed in updating the strategy may be, therefore, the experience(s) gathered during the project. Similarly, the method 300 can include experience(s) data as an input to updating a plan and/or metaplan.

The strategy that guides the project development can consider various project parameters. For example, a strategy may consider parameters including, but not limited to, return on investment, software reusability, the ability to expose information in new manners, Web services development personnel, Web services supporting technology, Web services project partners, and so on. Similarly, testing a Web service component can include evaluating various component parameters. For example, a Web service component may be tested on parameters including, but not limited to, Web service component reliability, Web service component scalability, Web service component interoperability, and Web service component accessibility. Similarly, calculating the effect of the Web service component on return on investment for the Web services project may include analyzing factors including, but not limited to, Web service component costs and Web service component related revenues.

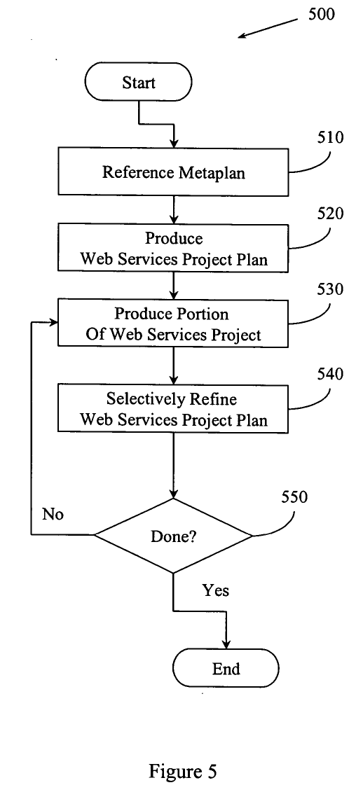

To further illustrate an incremental development process associated with Web services project metaplans and plans, FIG. 5 illustrates an example method 500 for incrementally refining a Web services project plan. Method 500 begins, at 510, by referencing a Web services project metaplan. At 520, a Web services project plan is produced from the Web services project metaplan. Referencing the metaplan may include, for example, employing a logic to retrieve the metaplan and/or components of the metaplan from a data store. Similarly, producing the project plan may include, for example, employing a logic to display, select, and/or exclude referenced metaplan elements.

Having produced the project plan, the method 500 may include, at 530, producing (e.g., programming) a portion of the Web services project according to the Web services project plan and, at 540, selectively refining the Web services project plan based on observing the portion. Thus, refining a project plan may be based, at least in part, on strategy changes produced during the development process. Refining the project plan can include, for example, altering a delivery data, altering the order in which Web services are to be produced, altering the development team, changing development tools, changing collaboration partners, recalculating return on investment, and so on. Refining the project plan facilitates more accurately matching project outcome to project plan by incorporating feedback about the project into the plan. Thus, in method 500, the Web services project plan developed from the metaplan may be a dynamic plan that adapts to the reality of the developing project.

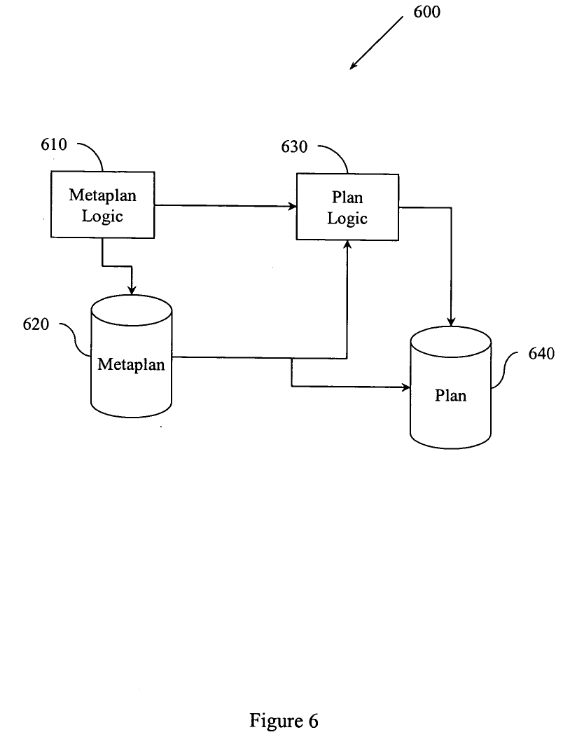

FIG. 6 illustrates an example system 600 for producing a Web services project plan. The system 600 includes a first logic 610 (e.g., a metaplan logic) that may be configured to produce a Web services project metaplan 620. By way of illustration, the first logic 610 may be configured to perform methods like those described in connection with FIGS. 1 and 3 to produce the metaplan 620. The metaplan 620 may be stored, for example, in a computer-readable medium and/or a data store. The system 600 may also include a second logic 630 (e.g., a plan logic) operably connected to the first logic 610. The second logic 630 may be configured to produce a Web services project plan 640 from the Web services project metaplan 620. By way of illustration, the second logic 630 may be configured to perform methods like those described in connection with FIGS. 2 and 5.

The system 600 may interact with a user who provides values for metaplan criteria and makes decisions that lead to forming the plan 640. Additionally, and/or alternatively, the first logic 610 and/or the second logic 630 may be programmed with artificial intelligence configured to produce the metaplan 620 and/or the plan 640 by considering project parameters like desired project completion date, cost, complexity, reliability, security and so on. Thus, in one example, the first logic 610 may be configured to produce the Web services project metaplan 620 by establishing, alone and/or in conjunction with a user, a set(s) of criteria that facilitate planning a Web services project. Similarly, in one example, the second logic 630 may be configured to produce the Web services project plan 640 by providing, alone and/or in conjunction with a user, a value(s) for a member(s) of the set(s) of criteria.

Thus, the first logic 610 may function as means for producing a Web services project metaplan 620. Those means may include software, hardware, and/or firmware as embodied in, for example, a logic. Similarly, the second logic 630 may function as means for producing a Web services project plan 640 from the Web services project metaplan 620. Those means may include software, hardware, and/or firmware as embodied in, for example, a logic. Similarly, the second logic 630 may serve as means for refining the Web services project plan 640 based on feedback data acquired from testing a portion(s) of a Web services project built according to the Web services project plan 640.

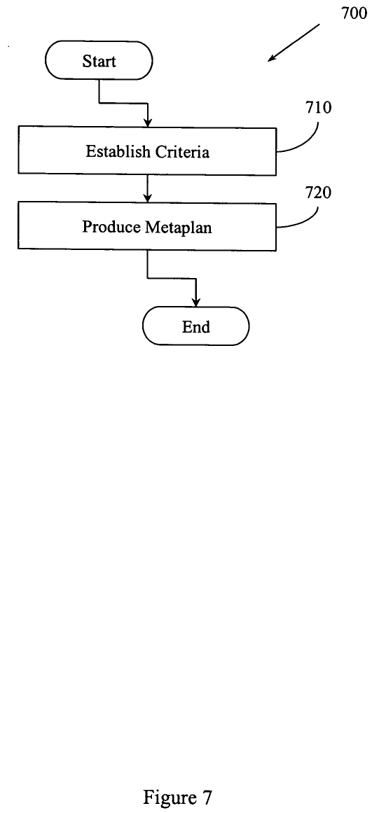

FIG. 7 illustrates a method 700 for producing a metaplan. The method 700 includes, at 710, establishing one or more criteria that facilitate planning a Web services project. These criteria may take the form of questions to find answers for, variables to find values for, queries to locate data, processes to guide thinking, and so on. Example criteria may include those described in association with method 100 (FIG. 1). The method 700 also includes, at 720, producing a metaplan. The metaplan may be stored, for example, as data in a data store or on a computer-readable medium. Additionally and/or alternatively, the metaplan may be stored as a process in a logic, for example.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A method, comprising:
establishing a first set of criteria for calculating a Web services project return on investment;
establishing a second set of criteria for identifying an existing reusable software component;
establishing a third set of criteria for identifying how to expose an existing software asset via a Web service;
establishing a fourth set of criteria for determining whether to include a Web service in a Web services project;
establishing a fifth set of criteria for determining whether to employ a Web services supporting technology;
establishing a sixth set of criteria for identifying a Web services development team;
establishing a seventh set of criteria for identifying one or more of, a project collaboration partner, and how to collaborate with a project collaboration partner; and
selectively organizing one or more members of the first through seventh sets of criteria into a Web services project metaplan.

2. The method of claim 1, including:
establishing an eighth set of criteria for analyzing an ongoing Web services development project; and
updating the metaplan to include one or more members of the eighth set of criteria.

3. The method of claim 1, where the first set of criteria includes one or more of, a Web services project development time, a Web services project actual development cost, a Web services project opportunity cost, a Web services project cost savings, and a Web services project anticipated effect on revenue.

4. The method of claim 1, where the second set of criteria includes one or more of, an existing reusable software component to Web service development time, an existing reusable software component to Web service development effort, an existing reusable software component to Web service development cost, and an existing reusable software component to Web service return on investment.

5. The method of claim 1, where the third set of criteria includes one or more of, an extensible markup language (XML) orientation for the existing software asset, a SOAP orientation for the existing software asset, a Web services description language (WSDL) orientation for the existing software asset, and a hypertext markup language (HTML) orientation for the existing software asset, where a software asset may include an application or a data set.

6. The method of claim 1, where the fourth set of criteria includes one or more of, a Web service integration cost, a Web service information exposure, a Web service business process need satisfaction, a Web service integration value, a Web service effect on return on investment, a Web service return on investment latency, a Web service return on investment measurability, a Web service operational efficiency, a Web service reliability, a Web service security, a Web service scalability, a Web service maturity, a Web service granularity, a Web service XML usage, a Web service WSDL usage, a Web service SOAP usage, and a Web service business process mapping.

7. The method of claim 1, where the fifth set of criteria includes one or more of, a Web services supporting technology reliability, a Web services supporting technology scalability, a Web services supporting technology security, a Web services supporting technology interoperability, a Web services supporting technology standards orientation, a Web services supporting technology best business practices capturing value, a Web services supporting technology development time, a Web services supporting technology cost, a Web services supporting technology language independence, a Web services supporting technology platform independence, a Web services supporting technology ease of use, a Web services supporting technology XML schema mapping support, a Web services supporting technology WSDL orientation, an information exposure value, and a Web services supporting technology legacy system adaptability.

8. The method of claim 1, where the sixth set of criteria includes one or more of, a development team member skill set preferred for a project, a development team member experience, a development team member business knowledge, a development team member willingness to participate in return on investment analysis, and a development team member ability to capture best business practices.

9. The method of claim 1, where the seventh set of criteria includes one or more of, a partner experience with previous Web services projects, a partner XML orientation, a partner WSDL orientation, a partner ability to agree on tag names and meanings, and a partner ability to work incrementally.

10. A method for producing a Web services project plan, comprising:
referencing a Web services project metaplan;
selectively providing one or more values for one or more elements of the referenced Web services project metaplan; and
producing the Web services project plan in response to analyzing the one or more values.

11. The method of claim 10, including:
developing a portion of a Web services project based, at least in part, on the Web services project plan; and
selectively refining the Web services project plan in response to analyzing the portion of the Web services project.

12. The method of claim 11, where analyzing the portion of the Web services project includes evaluating an effect of one or more of, an existing reusable software component, an information exposure technique, a Web services supporting technology, a Web services developer, a project collaboration partner, and a developed Web service on one or more of, a project complexity, a project time to market, a project return on investment, and a project capability.

13. The method of claim 12, including selectively repeating one or more actions of the method of claim 10 based, at least in part, on the refined Web services project plan.

14. A method, comprising:
selecting a return on investment evaluation method for evaluating one or more of, a predicted return on investment for a Web services project, and an ongoing return on investment for a Web services project;
creating an existing software asset identification process for identifying an existing software asset that can be included in the Web services project;
creating a Web service identification process for identifying one or more Web services that can be included in the Web services project;
acquiring industry data that identifies one or more of, available Web services software, emerging Web services software, available Web services hardware, emerging Web services hardware, existing Web services standards, and emerging Web services standards;
creating a Web services tool evaluation process for evaluating information about one or more Web services tools;
creating a Web services platform vendor evaluation process for evaluating information about one or more Web services platform vendors;
assembling a Web services project development team based, at least in part, on the return on investment evaluation method, the existing software asset identification process, the Web service identification process, the industry data, the Web services tool evaluation process, and the Web services platform vendor evaluation process; and
producing a Web services project metaplan, where a Web services project can be developed in two or more increments according to a Web services project plan developed from the metaplan.

15. The method of claim 14, including:
developing a Web services project increment according to the Web services project plan; and
selectively refining the Web services project plan for one or more remaining Web services project increments based on analyzing the developed Web services project increment.

16. The method of claim 15, where analyzing the developed Web services project increment includes evaluating one or more of, an increment cost, an increment revenue, an increment satisfaction, and an increment information exposure value.

17. The method of claim 16, including selectively repeating one or more actions of the method of claim 14 based, at least in part, on analyzing the developed increment.

18. A method, comprising:
developing a strategy for developing a Web services project that includes one or more Web service components;
programming a Web service component of the Web services project based on the strategy;
testing the Web service component;
calculating the effect of the Web service component on a return on investment for the Web services project; and
selectively updating the strategy based on the effect of the Web service component on the return on investment.

19. The method of claim 18, where the strategy considers return on investment, software reusability, the ability to expose information in new manners, Web services development personnel, Web services supporting technology, and Web services project partners.

20. The method of claim 18, where testing the Web service component includes testing one or more of, a Web service component reliability, a Web service component scalability, a Web service component interoperability, and a Web service component accessibility.

21. The method of claim 18, where calculating the effect of the Web service component on return on investment for the Web services project includes analyzing one or more of, a Web service component related cost, and a Web service component related revenue.

22. A Web services project development method, comprising:
referencing a Web services project metaplan;
producing a Web services project plan from the Web services project metaplan; and
one or more times:
producing a portion of the Web services project according to the Web services project plan; and
selectively refining the Web services project plan based on observing the portion.

23. A system, comprising:
a first logic configured to produce a Web services project metaplan; and
a second logic operably connected to the first logic, the second logic configured to produce a Web services project plan from the Web services project metaplan.

24. The system of claim 23, where the first logic is configured to produce the Web services project metaplan by establishing one or more sets of criteria that facilitate planning a Web services project.

25. The system of claim 24, where the second logic is configured to produce the Web services project plan by providing one or more values for one or more members of the one or more sets of criteria.

26. A system, comprising:
means for producing a Web services project metaplan;
means for producing a Web services project plan from the Web services project metaplan; and
means for refining the Web services project plan based on feedback data acquired from testing one or more portions of a Web services project built according to the Web services project plan.

27. A computer-readable medium having stored thereon a data structure comprising:
a first field containing data representing criteria for calculating a Web services project return on investment;
a second field containing data representing criteria for identifying an existing reusable software component;
a third field containing data representing criteria for identifying how to expose an existing software asset via a Web service;
a fourth field containing data representing criteria for determining whether to include a Web service in the Web services project;
a fifth field containing data representing criteria for determining whether to employ a Web services supporting technology;
a sixth field containing data representing criteria for identifying a Web services development team;
a seventh field containing data representing criteria for identifying a project collaboration partner;
an eighth field containing data representing criteria for analyzing an ongoing Web services development project; and
a ninth field containing data representing a Web services project metaplan derived from data stored in one or more of the first through eighth fields.

28. A method, comprising:
establishing one or more sets of criteria for characterizing a Web services project; and
producing a Web services project metaplan from one or more elements of the one or more sets of criteria.

29. The method of claim 28, comprising:
producing a Web services project plan from the Web services project metaplan.

30. A computer-readable medium having stored thereon a data structure comprising:
one or more first fields containing one or more criteria for characterizing a Web services project; and
a second field containing data representing a Web services project metaplan derived from criteria stored in one or more of the first fields.
